(19) United States
(12) Patent Application Publication
(10) Pub. No.: US 2005/0031177 A1
(43) Pub. Date: Feb. 10, 2005

(54) Automated computer-assisted diagnosis apparatus

(76) Inventors: William Langille, Amherst, NH (US); Janet Sterritt, Hollis, NH (US); Greg Gustafson, Independence, MN (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/876,265

(22) Filed: Jun. 24, 2004

Related U.S. Application Data
(60) Provisional application No. 60/480,947, filed on Jun. 24, 2003.

(51) Int. Cl. G06K 9/00

(52) U.S. Cl. 382/128

(57) ABSTRACT

An automated computer-assisted diagnosis (CAD) system, and, in particular, a CAD method using a self-contained apparatus that minimizes and streamlines the installation, use and exploitation of the CAD procedure as applied to, e.g., breast cancer detection. The apparatus and method for CAD application as disclosed herein minimizes or avoids site preparation, occupies minimal space and avoids the more complex and maintenance intensive CAD systems currently available to the market.

### CROSS REFERENCE TO RELATED APPLICATIONS

The present application claims the benefit of the filing date of U.S. Provisional Application Ser. No. 60/480,947, filed Jun. 24, 2003, the teachings of which are incorporated herein by reference.

### FIELD OF THE INVENTION

The present invention relates generally to an automated computer-assisted diagnosis (CAD) system, and, in particular, to a CAD method using a self-contained apparatus that minimizes and streamlines the installation, use and exploitation of the CAD procedure as applied to, e.g., breast cancer detection. The apparatus and method for CAD application as disclosed herein minimizes or avoids site preparation, occupies minimal space and avoids the more complex and maintenance intensive CAD systems currently available to the market.

### BACKGROUND OF THE INVENTION

Computer-assisted diagnosis has developed into an important technology in many different clinical applications. However, one of the more prevalent clinical applications for computer-assisted diagnosis is in the detection of breast cancer in women. According to the American Cancer Society, breast cancer is the most common cancer among women, other than skin cancer. It is the leading cause of death among women aged 40 to 55. Some studies suggest that there are approximately 179,000 new cases of breast cancer in the United States each year and about 43,500 deaths from the disease.

While there are presently no means for preventing breast cancer, early detection of the disease prolongs life expectancy and decreases the likelihood of the need for a total mastectomy. Accordingly, the American Cancer Society recommends that all women aged 40 and older should have a mammogram every year.

Not surprisingly, current technology has now developed to the point such that human evaluation of x-ray mammograms is seldom done in isolation. In that regard, there are a number of reports in the literature that now make use of CAD products which collectively seek to improve upon their operation to provide more reliable diagnostic information to the attending physician. In addition, while these efforts have certainly met with various levels of success, there has nonetheless been an on-going need to provide a CAD based system that is much more user friendly, and which facilitates the introduction of CAD technology to more and more clinics throughout the world.

However, while such objective has remained prominent, it is important to keep in mind that simplification of operation, itself, should not be carried out with any compromise on the CAD software technology developed to date and associated with CAD operation. Or, stated another way, while simplified and user friendly operation remains a prominent goal, such operation should not compromise the CAD system software cancer detection protocols, otherwise, the goal of user friendly operation, would in effect, be defeated. In addition, it is also important to maintain the quality and reliability of the scanning hardware, without, e.g., the sacrifice of the electro-optical hardware technology associated with currently accepted CAD equipment to identify those pathologies related to cancer.

Along such lines, attention is directed to WO03/009209 entitled “Computer-Aided Method And System For Detecting Spiculated Lesions In a Mammogram”. Disclosed therein is a computer-aided method and system for detecting spiculated lesions in a digital mammogram. Multiple bins are defined around a pixel or a group of pixels of the digital mammogram. Each of the bins is divided into multiple depth regions with differing distance characteristics relative to the pixel or group of pixels. Spiculation information is computed and correlated to at least one of the depth regions. Then, the spiculation information for a combination of depth regions is analyzed to detect spiculated lesions.

Attention is also directed to WO03/027955 entitled “Computer Aided Method And System For Processing Digital Mammograms To Identify Abnormalities.” Disclosed therein is a computer-aided method and system for processing a digital mammogram to identify abnormalities. The system generates a line strength image from at least a portion of the digital mammogram. After identifying first pixel groups of multiple pixels in the line strength image, the systems generates a scaled line strength image having multiple pixels from the line strength image. One or more pixels of the scaled line strength image correspond to first pixel groups of the line strength image. Values of the one or more pixels of the scaled line strength image are determined using a fist subset of pixels of its corresponding first pixel group, wherein the first subset comprises less than all of the pixels in the first pixel group.

Finally, attention is also directed to U.S. application Ser. No. 10/292,514 entitled “Method And System Of Tracking Medical Films And Associated Digital Images For Computer-Aided Diagnostic Analysis.” Disclosed therein is a method and system for tracking medical images and associated digital images for diagnostic evaluation. The system includes a scanner for digitizing one or more medical images defining a case to thereby produce one or more digitized medical images and for reading a machine-readable tracking identifier attached to each medical image of the case. A server associates the tracking identifier with one or more digitized medical images and one or more computer-aided diagnostic (CAD) images, wherein the one or more CAD images correspond to the one or more digitized medical images that are processed using a CAD algorithm. The system stores the associated tracking identifier, the one or more digitized medical images, and the one or more CAD images in a storage device. The server receives and processes a medical image request including the tracking identifier to retrieve at least one of the one or more digitized medical images or the one or more CAD images from the storage device using the tracking identifier.

In addition, quite apart from the software developments noted above as applied to CAD technology, hardware developments have advanced and are contributing to the development of this field. For example, attention is also directed herein to U.S. Pat. No. 6,697,173 entitled “White Reference Calibration In A Dual Digitizer.” As disclosed therein, a dual digitizer is provided for digitizing both transparent and reflective data mediums wherein light from a reflective illuminator reflects off the transparent illuminator when the transparent illuminator is off to provide a white reference signal for use in calibrating the dual digitizer. Such dual digitizer may therefore be used in medical applications to digitize a transparent data medium such as X-ray film.

Attention is also directed to U.S. Pat. No. 6,687,025 entitled “Digitizer With Masking Apparatus”, U.S. application Ser. No. 10/373,999 entitled “Scanning System For Identifying And Labeling X-Rays” and U.S. application Ser. No. 10/313,764 entitled “Digitizer With Improved Dynamic Range And Photometric Resolution.”

### SUMMARY OF THE INVENTION

An automated computer assisted diagnostic (CAD) apparatus and associated method, with no graphical user interface, comprising an input feeder to input one or a plurality of X-ray films, wherein said films are to be converted into one or more digital images by a digitizer. The apparatus includes a computer-implemented system including a scanner and digitizer for producing and processing said one or more digital images to identify potential abnormalities. A database is provided for directly receiving and transferring said one or more digital images with said identified potential abnormalities along with a printer means for displaying said one or more digital images. The printer means is in communication with said database for receiving and transferring said one or more digital images with said identified potential abnormalities. A counter system may then be included for counting said one or more digital images containing said identified potential abnormalities produced by said computer-implemented system, wherein said counter system is programmed to limit said number of X-ray films to be converted into said digital images containing said identified potential abnormalities.

In related embodiment, an automated computer assisted diagnostic (CAD) apparatus is provided to assist in the detection of mammographic abnormalities, also with no graphical user interface, comprising an input feeder to input a plurality of X-ray films that contain a plurality of different views of the breast region, wherein said films are to be converted into a plurality of digital images by a digitizer. A computer-implemented system is provided that includes a scanner and digitizer for producing and processing said plurality of digital images to identify potential abnormalities along with a database for directly receiving and transferring said plurality of digital images with said identified potential abnormalities. A printer means is included for displaying said plurality of digital images to a single page, wherein said printer means is in communication with said database for receiving and transferring said plurality of digital images with said identified potential abnormalities. A counter system may then be included for counting said plurality of digital images containing said identified potential abnormalities produced by said computer-implemented system, wherein said counter system is programmed to limit said number of X-ray films to be converted into said digital images containing said identified potential abnormalities.

In still further embodiment, the present invention is directed at an automated computer assisted diagnostic apparatus, with no graphical user interface, for processing one or a plurality of medical films to produce an output with highlighted potential abnormalities, comprising a digitizer for producing a digital image of the medical film, a computer for processing the digital image to identify potential abnormalities, and a printer in communication with said computer for producing a printed version of the digital image with highlighted potential abnormalities.

The invention here also relates to an automated computer assisted diagnostic apparatus, with no monitor, for processing one or a plurality of medical films to produce an output with highlighted potential abnormalities, comprising a digitizer for producing a digital image of the medical film, a computer for processing the digital image to identify potential abnormalities, and a printer in communication with said computer for producing a printed version of the digital image with highlighted potential abnormalities.

The invention herein also includes an automated computer assisted diagnostic apparatus, with no keyboard, for processing one or a plurality of medical films to produce an output display with highlighted potential abnormalities, comprising a digitizer for producing a digital image from the medical film, a computer for processing the digital image to identify potential abnormalities, and a printer in communication with said computer for producing a printed version of the digital image with highlighted potential abnormalities.

The present invention further includes an automated computer assisted diagnostic apparatus, with no monitor and no keyboard, for processing one or a plurality of medical films to produce an output display with highlighted potential abnormalities, comprising a digitizer for producing a digital image from the medical film, a computer for processing the digital image to identify potential abnormalities, and a printer in communication with said computer for producing a printed version of the digital image with highlighted potential abnormalities.

In a still further embodiment the present invention relates to an automated computer assisted diagnostic apparatus for processing one or a plurality of medical films to produce an output with highlighted potential abnormalities, comprising, a digitizer for producing a digital image of the medical film, a computer for processing the digital image to identify potential abnormalities, a printer in communication with said computer for producing a printed version of the digital image with highlighted potential abnormalities, and a counter system for counting the digital images produced by the digitizer, wherein the counter system is programmed to limit the number of films to be converted into digital images.

### BRIEF DESCRIPTION OF THE DRAWINGS

FIG. 1 illustrates the automated computer assisted diagnostic apparatus of the present invention.

FIG. 2 illustrates an exemplary output showing the images provided as applied to assist in the detection of mammographic abnormalities.

FIG. 3 illustrates an exemplary administrative report of the automated computer assisted apparatus of the present invention, including a problem report.

FIG. 4 illustrates an exemplary output of the automated computer assisted apparatus when the apparatus is not properly provided with X-ray films for CAD analysis.

### DETAILED DESCRIPTION OF THE PREFERRED EMBODIMENTS

As noted above, the present invention is directed to an apparatus which provides automated computer-assisted diagnosis (CAD). The system hardware and software associated with such CAD analysis is more fully described, e.g. in the above referenced published applications WO 03/009209, WO 03/027955 and U.S. application Ser. No. 10/292,514, whose teachings are all herein incorporated by reference.

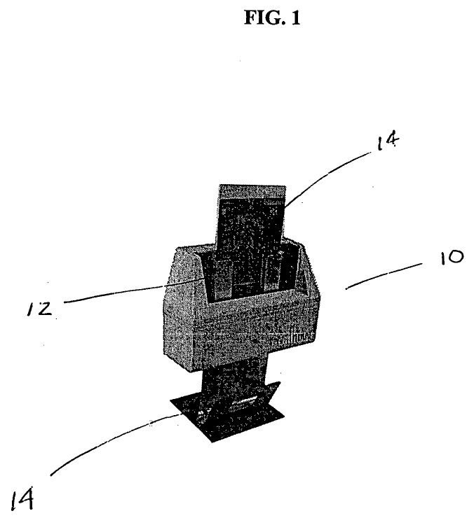

As illustrated in FIG. 1, the automated computer assisted apparatus of the present invention is preferably configured to operate in a manner similar to a fax machine. Specifically, the apparatus 10 contains a film input feeder section 12 which allows for sequential feeding of one or a plurality of X-ray films 14 into the device 10. As shown in FIG. 1, the X-ray films are preferably vertically arranged so that they are sequentially scanned and digitized by a digitizer to produce a digital image for detecting abnormalities. Apparatus 10 therefore contains a computer-implemented system including a scanner and digitizer for producing and processing the one or more digital images produces from scanning the one or more X-ray films provided by the input feeder. Upon completion of scanning of the films, they are preferably delivered to a holder 14 wherein a technician can collect said films for future use.

As can be seen from FIG. 1, the apparatus 10 herein does not make use of a graphic user interface, and is automated in the sense that the technician need only load the films 14 into the device 10, and no graphical user interface, screen or keyboard is required. That apparatus herein thereby provides a compact, stand-alone system, and the technician effectively inserts the X-ray film, and the apparatus herein detects the case, feeds and scans the films, analyzes the image for possible cancer and prints an output with potential cancers circled or highlighted.

Accordingly, the system herein provides ease of use and self-training of operators, no installation of site preparation, a footprint comparable to an ordinary fax machine, and affordability for the small clinic type market. In that regard, the system herein can be programmed to charge the clinician on an as-needed basis, thereby further reducing the operating costs of CAD technology in the marketplace. In other words, the system herein preferably contains and is programmed to contain a “click CAD fee”, in the sense that the clinician is charged only for those events in which the system herein operates to provide CAD analysis. The system may therefore preferably contain the associated hardware/software such that the number of click CAD fees are programmed within the system, or the system may also be connected via an internet or similar type connection to a master server wherein the click CAD fee is recorded and charged on an accrual type or other related accounting basis.

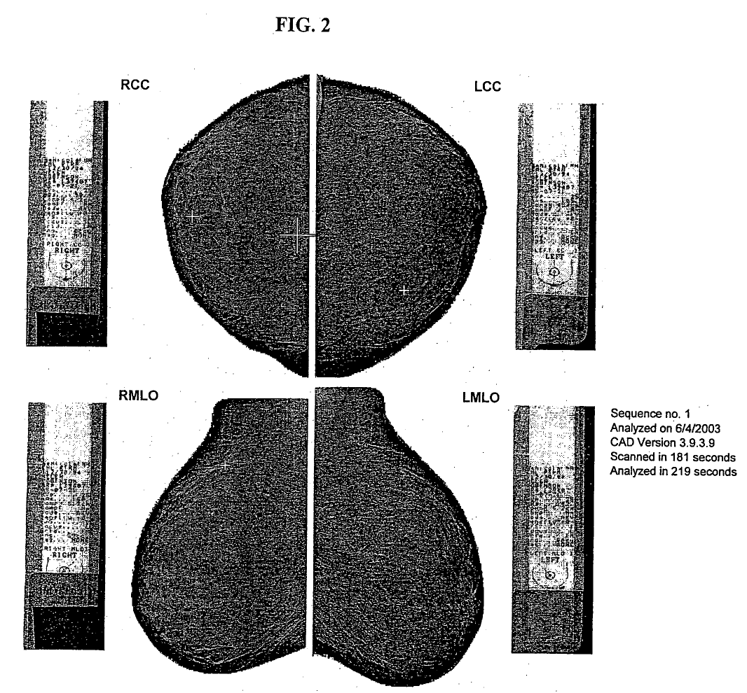

Attention is next directed to FIG. 2 which illustrates an exemplary output showing images provided of the system herein to assist in the detection of mammographic abnormalities. More specifically, in the field of mammography, a radiological study typically entails the exposure of four X-ray films that contain four different views of the breast region. The four views are commonly identified as RMLO, RCC, LMLO and LCC views. Using the automated system 10 of the present invention, the technician provides the four films for introduction at the input feeder section 12. Following scanning, digitization, and CAD analysis, the system herein provides the exemplary output report provided in FIG. 2, wherein the four views (RMLO, RCC, LMLO and LCC) are located on a single page, along with the patient identification coding adjacent each image. In addition, the apparatus herein will identify to the technician certain core aspects of the scan, such as the overall sequence number, date of analysis, the particular version of the CAD software employed, the scanning time, and the time spent for CAD analysis.

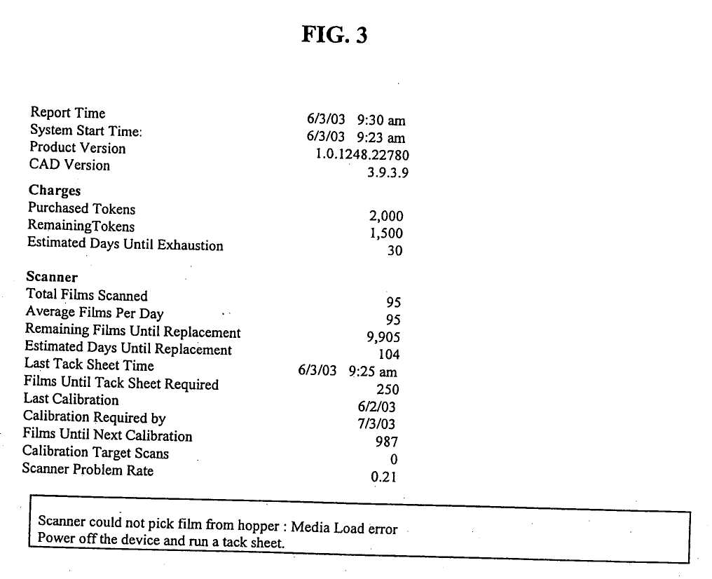

Attention is next directed to FIG. 3, which illustrates an exemplary report including a “problem report” that may be provided by the apparatus herein output to the associated printer means. As an initial matter, and as noted above, the system herein preferably provides what has been identified as a click CAD fee so that the system charges the user on an as need basis. Along such lines the report illustrated in FIG. 3 will confirm the status of this feature of operation, providing, e.g., confirmation of the number of CAD scans purchased (identified as “purchased tokens”), the number of “remaining tokens”, and an estimate (based upon operating use) of the number of days until exhaustion. Furthermore, the printed report preferably identifies the total number of films scanned per day, the number of remaining films to be scanned until recommended replacement, and the estimated days to replacement of the dongle (encrypted chip) which controls the number of pre-purchased scans available to the user. In addition the apparatus also confirms the last time a tack (cleaning card) or test (calibration) film was provided for calibration, and the number of films that may be scanned until a new calibration film must be implemented.

Other types of information provided includes the identification of a projected calibration date, the number of films that can be scanned until calibration, calibration target scans (i.e., the number of times a particular calibration film has been utilized for calibration), a “scanner problem rate” (i.e. a programmed calculation of percent failure for the number of operational scans), and when the operator should clean the apparatus. In addition, as can be seen in FIG. 3, the report may also include the identification of a particular problem in the apparatus, and as illustrated, whether or not the scanner itself could pick film from the hopper input feeder. In that regard, the apparatus can issue a command correction protocol, notify the technician of the remedial actions that may be necessary to reconfigure and return the subject apparatus 10 back into acceptable CAD operation. Furthermore, expanding upon the above, it can be appreciated that the apparatus herein reports to the operator as noted, and thereby includes the ability to monitor scanner usage and performance as well as processing performance for preventative maintenance.

In another embodiment, the system monitors and reports the number of cases processed or remaining, based on a predetermined average number of films per case, typically about 4.

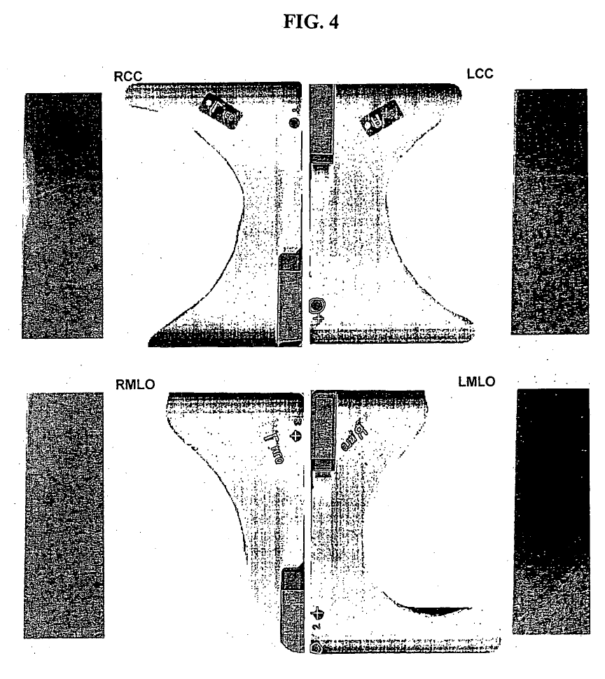

Attention is next directed to FIG. 4, which illustrates an exemplary output when the apparatus herein is improperly provided with X-ray films in a typical radiological study of mammography. Specifically, FIG. 4 illustrates the result when the technician improperly sequences the RMLO, RCC, LMLO and LCC views. As can be seen, owing to the CAD software of the apparatus 10, the system is not able to properly recognize the X-ray films, and therefore does not provide the CAD analysis that it is otherwise programmed to deliver. In this situation, the technician is provided a different output in the sense that the information required from the film for digitization is not digitized (due to misalignment as a consequence of incorrect loading of the input feeder 14), and the CAD operation is not undertaken. In addition, under these circumstances, the apparatus will not initiate a click charge fee, so that the user can take corrective action without incurring additional costs.

Accordingly, in an effort to minimize the occurrence of the type of event illustrated in FIG. 4, the system 10 also preferably includes an input device in communication with the system database which input device can instruct the database as to the presence or absence of any one of the four X-ray films containing the RMLO, RCC, LMLO and LCC views. In this fashion, the system is then notified that a particular view may be absent, and thereby proceed to CAD analysis. Preferably, such input device comprises a pushbutton type device, where each button is labeled RMLO, RCC, LMLO and LCC. In a preferred embodiment, the pushbuttons may be identified with the names or diagrams of the views and equipped with an internal light; by convention, when the light is on, the view corresponding to the button is understood to be available. In such fashion, the technician then can conveniently inform the system as to which view may be absent in a given analysis.

It will therefore be apparent to those skilled in the art that various modifications and variations can be made to the method and apparatus for processing X-ray films disclosed herein. Thus, it is intended that the present invention cover the modifications and variations of this invention as defined by the appended claims.

1. An automated computer assisted diagnostic (CAD) apparatus, with no graphical user interface, comprising:
(a) an input feeder to input one or a plurality of X-ray films, wherein said films are to be converted into one or more digital images by a digitizer;
(b) a computer-implemented system including a digitizer for producing and processing said one or more digital images to identify potential abnormalities;
(c) a database for directly receiving and transferring said one or more digital images with said identified potential abnormalities;
(d) a printer means for displaying said one or more digital images, said printer means in communication with said database for receiving and transferring said one or more digital images with said identified potential abnormalities;
(e) a counter system for counting said one or more digital images containing said identified potential abnormalities produced by said computer-implemented system, wherein said counter system is programmed to limit said number of X-ray films to be converted into said digital images containing said identified potential abnormalities.

2. The automated computer assisted diagnostic (CAD) apparatus of claim 1 wherein said counter system is programmed to signal said printer means to print an administrative report.

3. The automated assisted diagnostic (CAD) apparatus of claim 1 wherein said counter system is programmed to output to said administrative report an instruction to a user to either clean and/or run a calibration check of said apparatus, and wherein said counter system resets upon cleaning and/or calibration.

4. The automated assisted diagnostic (CAD) apparatus of claim 1 wherein said apparatus monitors and reports on digitizer usage, digitizer performance and processing performance for preventative maintenance.

5. An automated computer assisted diagnostic (CAD) apparatus to assist in the detection of mammographic abnormalities, with no graphical user interface, comprising:
(a) an input feeder to input one or a plurality of X-ray films that contain one or a plurality of different views of the breast region, wherein said films are to be converted into a plurality of digital images by a digitizer;
(b) a computer-implemented system including a scanner and digitizer for producing and processing said one or plurality of digital images to identify potential abnormalities;
(c) a database for directly receiving and transferring said one or plurality of digital images with said identified potential abnormalities;
(d) a printer means for displaying said one or plurality of digital images to a single page, said printer means in communication with said database for receiving and transferring said one or plurality of digital images with said identified potential abnormalities;
(e) a counter system for counting said one or plurality of digital images containing said identified potential abnormalities produced by said computer-implemented system, wherein said counter system is programmed to limit said number of X-ray films to be converted into said digital images containing said identified potential abnormalities.

6. The apparatus of claim 5 wherein said apparatus includes an input device in communication with said database which input device instructs said database as to the presence or absence of any one of said plurality of X-ray films containing views of said breast region.

7. The apparatus of claim 6 wherein said input device is a pushbutton device, each pushbutton corresponding to any one of said plurality of X-ray films, each pushbutton thereby configured to instruct said database as to the presence or absence of any one of said plurality of X-ray films containing views of said breast region.

8. The apparatus of claim 5 wherein said one or plurality of X-ray films comprises four different views of the breast region identified as RMLO, RCC, LMLO and LCC views.

9. The apparatus of claim 8 wherein said RMLO, RCC, LMLO and LCC views are printed by said printer means to a single page.

10. An automated computer assisted diagnostic apparatus, with no graphical user interface, for processing one or a plurality of medical films to produce an output with highlighted potential abnormalities, comprising:
(a) a digitizer for producing a digital image of the medical film;
(b) a computer for processing the digital image to identify potential abnormalities; and
(c) a printer in communication with said computer for producing a printed version of the digital image with highlighted potential abnormalities.

11. An automated computer assisted diagnostic apparatus, with no monitor, for processing one or a plurality of medical films to produce an output with highlighted potential abnormalities, comprising:
(a) a digitizer for producing a digital image of the medical film;
(b) a computer for processing the digital image to identify potential abnormalities; and
(c) a printer in communication with said computer for producing a printed version of the digital image with highlighted potential abnormalities.

12. An automated computer assisted diagnostic apparatus, with no keyboard, for processing one or a plurality of medical films to produce an output display with highlighted potential abnormalities, comprising:
(a) a digitizer for producing a digital image from the medical film;
(b) a computer for processing the digital image to identify potential abnormalities; and
(c) a printer in communication with said computer for producing a printed version of the digital image with highlighted potential abnormalities.

13. An automated computer assisted diagnostic apparatus, with no monitor and no keyboard, for processing one or a plurality of medical films to produce an output display with highlighted potential abnormalities, comprising:
(a) a digitizer for producing a digital image from the medical film;
(b) a computer for processing the digital image to identify potential abnormalities; and
(c) a printer in communication with said computer for producing a printed version of the digital image with highlighted potential abnormalities.

14. An automated computer assisted diagnostic apparatus for processing one or a plurality of medical films to produce an output with highlighted potential abnormalities, comprising:
(a) a digitizer for producing a digital image of the medical film;
(b) a computer for processing the digital image to identify potential abnormalities;
(c) a printer in communication with said computer for producing a printed version of the digital image with highlighted potential abnormalities; and
(d) a counter system for counting the digital images produced by the digitizer, wherein the counter system is programmed to limit the number of films to be converted into digital images.

15. The apparatus of claim 14 further comprising a providing a means for a user to effectively reduce the value of the count in the count system thereby allowing additional films to be converted to digital images.

16. The apparatus of claim 14 wherein said counter system is programmed to signal said printer means to print an administrative report.

17. The apparatus of claim 16 wherein said counter system is programmed to output to said administrative report an instruction to clean the digitizer, and wherein said counter system resets upon cleaning.

18. The apparatus of claim 16 wherein said counter system is programmed to output to said administrative report an instruction to run a calibration check of said digitizer, and wherein said counter system resets upon calibration.

19. The apparatus of claim 10 wherein said apparatus monitors and reports on digitizer usage, digitizer performance and processing performance for preventative maintenance.

20. The apparatus of claim 10 where the medical films are mammography films.

21. The apparatus of claim 10 wherein said apparatus includes an input device for an operator to indicate the presence or absence of any one of said plurality of X-ray films to be processed.

22. The apparatus of claim 21 wherein the input device is a pushbutton device, each pushbutton corresponding to any one of said plurality of X-ray films.

23. The apparatus of claim 22 wherein said one or plurality of X-ray films comprises two different views of right and left breasts.

24. The apparatus of claim 23 wherein the two different views comprise medial lateral oblique and cranio-caudal.

25. The apparatus of claim 23 wherein said views are printed to a single page.
